(19) United States
(12) Patent Application Publication
(10) Pub. No.: US 2026/0225054 A1
(43) Pub. Date: Aug. 6, 2026

(54) APPARATUS, SYSTEM, AND METHOD FOR AGITATING A FLUID

(71) Applicant: GLOBAL LIFE SCIENCES SOLUTIONS USA LLC, Marlborough, MA (US)

(72) Inventors: Kandakumar MURUGESAN, Bengaluru (IN); Subhanjan CHATTOPADHYAY, Bengaluru (IN)

(21) Appl. No.: 19/152,243

(22) PCT Filed: Feb. 5, 2024
(86) PCT No.: PCT/US2024/014373

§ 371 Date: Jul. 30, 2025

(30) Foreign Application Priority Data
Feb. 6, 2023 (IN) 202311007450

(51) Int. Cl. B01F 27/83; B01F 33/453; B01F 35/513

(52) U.S. Cl. CPC B01F 27/83; B01F 33/453; B01F 35/513

(57) ABSTRACT

A vessel includes an interior volume configured to contain a liquid and a rotatable impeller located within the interior volume. The vessel further includes an impeller guide configured to receive the impeller, the impeller guide being located within the interior volume and defining a substantially horizontal impeller travel path. Wherein when the impeller travels along the substantially horizontal impeller travel path, the impeller rotates axially to agitate a liquid in the interior volume.

### BACKGROUND

### Technical Field

Embodiments of the invention relate generally to bioprocessing apparatus, systems, and methods, and more particularly, to impellers used to agitate a fluid in a mixer or bioreactor bag.

### Discussion of Art

Mixers and bioreactors are often employed to carry out biochemical and/or biological processes and/or manipulate liquids and other products of such processes. Such mixers often include flexible or collapsible single-use disposable bags that are supported by an outer rigid structure such as a stainless-steel shell or housing. The bags are made of thin flexible sheets of plastic film and are positioned within the rigid housing and filled with the desired fluid for processing. The fluid within the bags requires mixing or agitation to prevent settling of particulates at the bottom of the bag.

Known mixing devices typically include a rotatable agitator or impeller that is fixedly mounted at the bottom of a disposable bag that is retained within a rigid tank or support structure. Such impellers typically have a base portion that contains permanent magnets that are magnetically coupled to and driven by permanent magnets of a motor. In use, the motor magnets are rotated which rotate the base portion of the impeller about a shaft resulting in agitation of a fluid within the bag.

In known systems, however, the fixed impeller is in a centrally located in the bottom of the bag. This fixed impeller location may result in inefficient mixing. In particular, the impeller agitates only a small volume of the total liquid and creates suction which contributes to settling of particulates from the liquid, typically to a location below the impeller and/or at the corners of the tank/vessel.

In some known systems, it may be desirable or necessary to have multiple impellers rotate about a shaft within a bag to facilitate efficient mixing of larger volumes. Such impellers, however, must be replaced with the single-use disposable bag and multiple impellers (which typically include permanent magnets) may result in a prohibitively expensive bag.

In view of the above, there is a need for an apparatus, system, and method for agitating a fluid in a mixer/bioreactor bag that provides for efficient mixing, the prevention of particulate settlement, and a lower cost of manufacture.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of the possible embodiments. Indeed, the disclosure may encompass a variety of forms that may be similar to or different from the embodiments set forth below

In an embodiment, a vessel includes an interior volume configured to contain a liquid and a rotatable impeller located within the interior volume. The vessel further includes an impeller guide configured to receive the impeller, the impeller guide being located within the interior volume and defining a substantially horizontal impeller travel path. Wherein when the impeller travels along the substantially horizontal impeller travel path, the impeller rotates axially to agitate a liquid in the interior volume.

In another embodiment of the invention, a stirred tank includes an interior configured to receive a vessel, the vessel containing an impeller capable of axial rotation and travel along a substantially horizontal impeller travel path, the vessel configured to receive a fluid. The stirred tank further includes an exterior that defines the interior and a coupling guide affixed to the exterior of the stirred tank. The coupling guide defining a substantially horizontal coupling travel path. Wherein the coupling guide is configured to receive an actuator coupling containing at least one magnet, the actuator coupling configured for magnetic engagement with the impeller such that when the actuator coupling travels within the coupling guide in the coupling travel path, the impeller travels along the substantially horizontal impeller travel path and rotates.

In yet another embodiment, a method of agitating fluid in a vessel includes moving a rotatable impeller in a substantially horizontal impeller travel path, the impeller travel path defined by an impeller guide located within an interior volume of the vessel. Wherein when the impeller is moved in the substantially horizontal impeller travel path, the impeller rotates axially to agitate a liquid in the interior volume.

### DRAWINGS

The present invention will be better understood from reading the following description of non-limiting embodiments, with reference to the attached drawings, wherein below:

FIG. 1 is a cross-sectional view of a known mixer depicting a fixed impeller and drive assembly.

FIG. 2 is an enlarged cross-sectional view of the fixed impeller and drive assembly of the mixer of FIG. 1.

FIG. 3 is a front cross-sectional view of a mixer/bioreactor having a substantially horizontal impeller travel path, according to an embodiment of the present invention.

FIG. 4 is an enlarged cross-sectional side view of an impeller and impeller guide of the mixer/bioreactor of FIG. 3.

FIG. 5 is a perspective view of an actuator, coupling guide, and impeller according to an embodiment of the present invention.

FIG. 6 is a perspective view of an exterior surface of a mixer/bioreactor depicting an actuator and coupling guide according to an embodiment of the present invention.

FIG. 7 is a perspective view of an interior of a mixer/bioreactor depicting an impeller, impeller guide and substantially horizontal impeller travel path according to an embodiment of the present invention.

FIG. 8 is a front cross-sectional view of a mixer/bioreactor having a substantially horizontal impeller travel path, according to an alternative embodiment of the present invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

As used herein, the term “flexible” or “collapsible” refers to a structure or material that is pliable, or capable of being bent without breaking, and may also refer to a material that is compressible or expandable. An example of a flexible structure is a bag formed of polyethylene film. The terms “rigid” and “semi-rigid” are used herein interchangeably to describe structures that are “non-collapsible,” that is to say structures that do not fold, collapse, or otherwise deform under normal forces to substantially reduce their elongate dimension. Depending on the context, “semi-rigid” can also denote a structure that is more flexible than a “rigid” element, e.g., a bendable tube or conduit, but still one that does not collapse longitudinally under normal conditions and forces.

A “vessel,” as the term is used herein, means a flexible bag, a flexible container, a semi-rigid container, or a rigid container, as the case may be. The term “vessel” as used herein is intended to encompass, but is not limited to, mixer or bioreactor vessels having a wall or a portion of a wall that is flexible or semi-rigid, single-use flexible bags, as well as other containers or conduits commonly used in biological or biochemical processing, including, for example, cell culture/purification systems, fermentation systems, media/buffer preparation systems, and filtration/purification systems.

As used herein, the term “bag” means a flexible or semi-rigid container or vessel used, for example, as a mixer or bioreactor for the contents within. While embodiments are described and depicted in connection with single-use, stirred tank mixer systems, they are not limited to the same and may be used with a variety of vessels and associated equipment used in biological or biochemical processing. Additionally, embodiments may be suitable for mixing or agitating fluids in other non-biological/biochemical contexts.

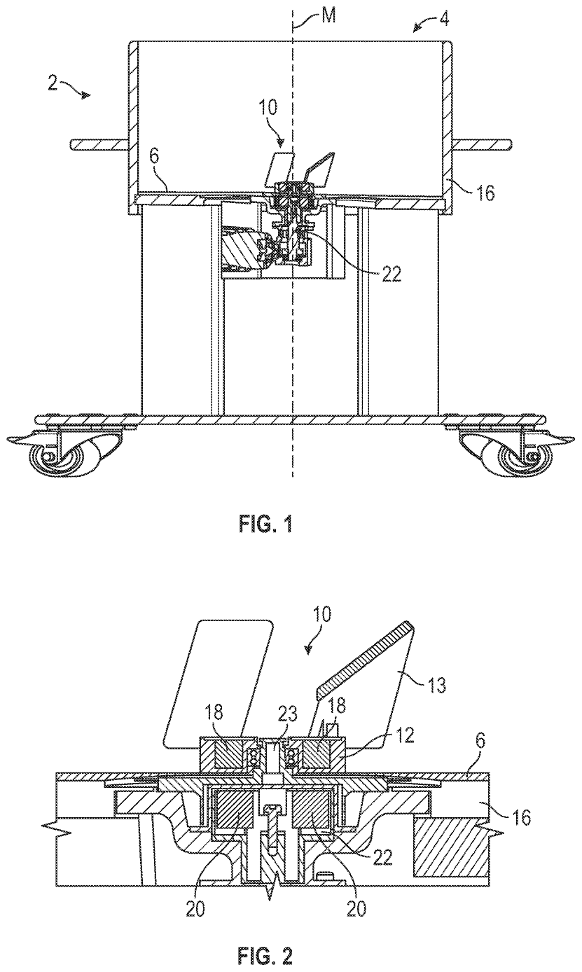

Referring now to FIGS. 1 and 2, a known mixer 2 is depicted. The mixer 2 includes a rigid tank or support structure 16, which may be formed, for example, from stainless steel, polymers, composites, glass, or other metals and may be rectangular or cylindrical in shape, although other shapes may be utilized, as long as it is capable of supporting a single-use flexible mixer or bioprocessing/bioreactor bag. The tank 16 has an interior 4, that is configured to receive a vessel, e.g., a flexible, single-use bag 6.

The vessel/bag 6 includes a rotatable agitator or impeller assembly 10 that is secured, e.g., welded, to a bottom surface of the bag 6 in a fixed location. As shown, this location is at an approximate midline M of the tank 16. The impeller assembly 10 has a base portion 12 that is mounted on shaft 23. The base portion 12 includes one or more blades 13 and permanent magnets 18 that, in use, are magnetically coupled to and driven by permanent magnets 20 of a motor 22. In use, the motor magnets 20 are rotated, which rotate the base portion 12 of the impeller 10 about the shaft 23 resulting in agitation of a fluid within the bag.

As mentioned, the fixed location of the impeller 10 within the bag may result in inefficient mixing due to suction resulting from impeller rotation and the agitation of only a small volume of the total liquid both of which contribute to settling of particulates from the liquid, typically to a location below the impeller 10. Modifying the impeller 10 to act on more liquid, e.g., by increasing its size, requires larger magnets which are prohibitively expensive.

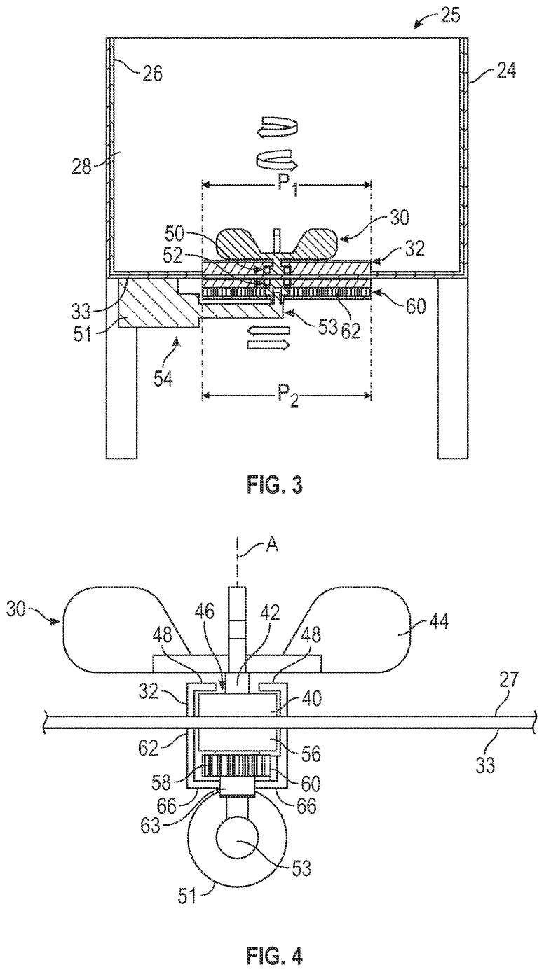

Referring now to FIG. 3, a stirred tank mixer/bioreactor 24 according to an embodiment of the present invention is depicted. The mixer/bioreactor 24 includes an interior 25 configured to receive and contain a vessel/bag 26 for fluid processing/mixing. As shown, the interior 25 of the mixer/bioreactor 24 is defined by an exterior that, in the depicted embodiment, includes plurality of side and bottom panels and an open top or upper surface configured to receive a vessel (e.g., bag) 26. The bottom panel or surface 33 of the mixer/bioreactor 24 is substantially horizonal.

As will be appreciated, while depicted as having a quadrilateral shape, the mixer/bioreactor 24 need not be any specific shape or form and cylindrical stirred tank mixers/bioreactors may be utilized without departing from the scope of the invention. Moreover, embodiments may be used with stirred tanks of varying sizes, though, in a specific embodiment, the stirred tank is a 2500 L mixer tank.

The vessel 26 has an interior volume 28 that is configured to contain a liquid for, e.g., mixing and/or bioprocessing. The interior volume 28 of the vessel 26 further includes a rotatable impeller 30 and, as shown, may include an impeller guide 32. The impeller guide 32 is secured to a bottom portion or surface 27 of the vessel 26. In embodiments, the impeller guide 32 may be secured via thermal welding or an adhesive to the bottom surface 27 of the vessel 26, though other means of attachment may be employed. In certain embodiments, the impeller guide 32 may be unitary with the vessel, e.g., formed from the vessel material as a part of the bottom surface 27 of vessel 26.

As depicted, in an embodiment, the impeller 30 is movably received within the impeller guide 32 such that the impeller guide 32 defines a substantially horizontal impeller travel path P₁ along the bottom surface 27 of the vessel 26. More specifically, the impeller 30 includes a generally circular base portion 40 that is attached to a shaft 42 to which a plurality of blades 44 are secured. In specific embodiments, there may be four blades, but, as will be appreciated, other numbers, shapes, and sizes of blades may be utilized without departing from the invention.

The base portion 40 is contained within the impeller guide 32 such that the shaft 42 extends from an open channel 46 in the impeller guide 32. The open channel 46 faces away from the bottom surface 27 and is open to the interior volume 28 of the vessel. The open channel 46 may have two rim or shoulder portions 48 that extend along the length of the impeller guide 32 narrowing the open channel 46 allowing the shaft 42 to extend out of the guide 32, while retaining the base portion 40 within the guide 32.

In embodiments, attachment mechanisms for retaining the base portion 40 within the guide 32 (other than shoulder portions 48) may be utilized without departing from the scope of the invention.

As described in greater detail below, the impeller guide 32 is configured, e.g., sized and shaped, to allow the base portion 40 to rotate and travel bidirectionally within the guide 32 along the substantially horizontal impeller travel path. In particular, when the impeller 30 travels within the impeller guide 32, the impeller 30 rotates axially about the spiral shaft 42 to mix or otherwise agitate a liquid in the interior volume 28.

In embodiments, movement of the impeller 30 within the impeller guide 32 may be facilitated by one or more impeller magnets 50 located within the base portion 40 of the impeller 30. In specific embodiments, the impeller magnets 50 are a plurality of permanent magnets that magnetically engage corresponding actuator magnets 52 that are located outside of the vessel 26. The actuator magnets 52 may be a plurality of permanent magnets. That said, in embodiments, the magnet(s) 50, 52 may be permanent or temporary and may be manufactured from steel, Iron, Cobalt, Nickel, and alloys thereof. The magnet(s) 50, 52 may be in a variety of shapes, sizes, and locations.

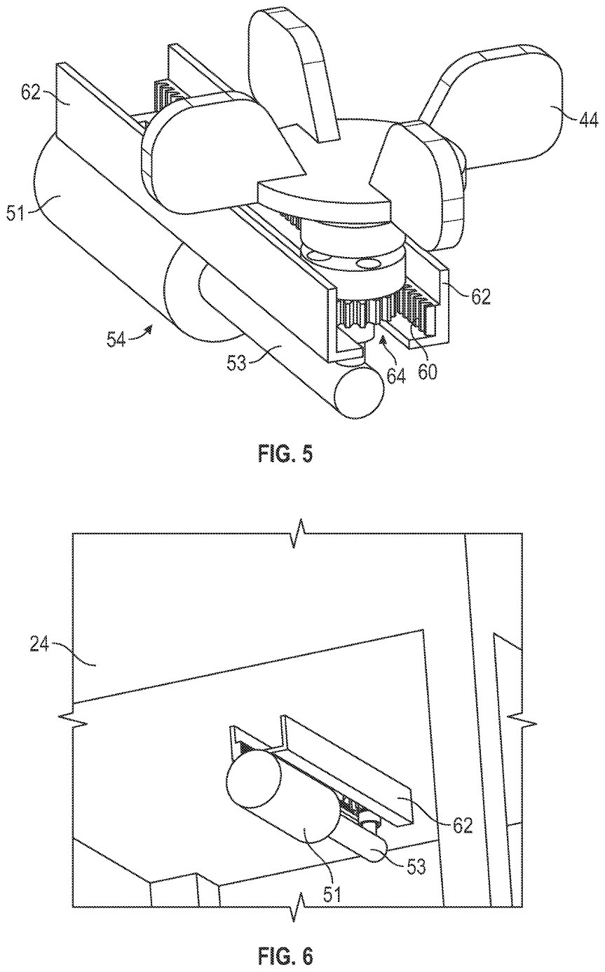

Referring now to FIGS. 3-6, the actuator magnets 52 are operatively connected to an actuator 54, e.g., a linear actuator, that allows the actuator 54 to move the impeller 30 bidirectionally along the substantially horizontal impeller travel path.

In embodiments, the actuator magnets 52 are located within a generally circular rotatable actuator coupling 56. In embodiments, the actuator coupling 56 includes a plurality of teeth 58 which are arranged circumferentially around a portion of the actuator coupling 56. The teeth 58 are configured to engage a rack of teeth 60 located within a coupling guide 62 which defines a substantially horizontal coupling travel path P₂. The actuator coupling 56 is connected to a rotatable actuator shaft 63 which is in turn connected to the actuator 54.

In embodiments, the coupling guide 62 has an open channel 64 that faces downward away from the bottom surface 33 of the mixer/bioreactor 24. The actuator coupling 56 is contained within the coupling guide 62 such that the shaft 63 extends from the open channel 64 in the coupling guide 62. The open channel 64 may have two rim or shoulder portions 66 that extend along the length of the coupling guide 62 narrowing the open channel 64 allowing the shaft 63 to extend out of the coupling guide 62 while retaining the actuator coupling 56 within the coupling guide 62.

In embodiments, the coupling guide 62 and/or the actuator 54 are fixed to a bottom surface of the exterior of the mixer/bioreactor 24. The guide 62 and actuator 54 may be welded to the bottom surface of the mixer/bioreactor 24 or fixed via adhesives or other mechanical or chemical means. In certain embodiments, the guide 62 and/or actuator 54 may be secured to a surface other than the depicted bottom exterior surface 33 of the tank 24. In other embodiments, the coupling guide 62 and mixer/bioreactor 24 bottom surface may be unitary, e.g., the bottom surface may be manufactured to include the guide 62.

In use, the linear actuator 54 includes a motor 51 that extends and retracts a piston-like pole portion 53. The pole portion 53 is operatively connected to the shaft 63, which is substantially perpendicular to the pole portion 53, about which the rotatable coupling 56 rotates. When the pole portion 53 extends and retracts, the circumferential teeth 58 of the coupling 56 engage the rack of teeth 60 within the coupling guide 62 causing the coupling 56 to rotate as it travels in the substantially horizontal coupling travel path defined by the coupling guide 62. The actuator magnets 52 of the coupling 56 are magnetically coupled to the impeller magnets 50 such that the travel and rotation of the coupling 56 causes the impeller 30 within the vessel 26 to rotate and travel within the impeller guide 32 in the substantially horizontal impeller travel path.

In particular, rotation of the coupling 56 causes the impeller 30 to rotate about longitudinal axis A. As will be appreciated, a change in direction of travel of the coupling 56 in the coupling guide 62 results in a change in direction of the impeller 30 within the impeller guide 32, which reverses the direction of rotation of the impeller 30 about the longitudinal axis A.

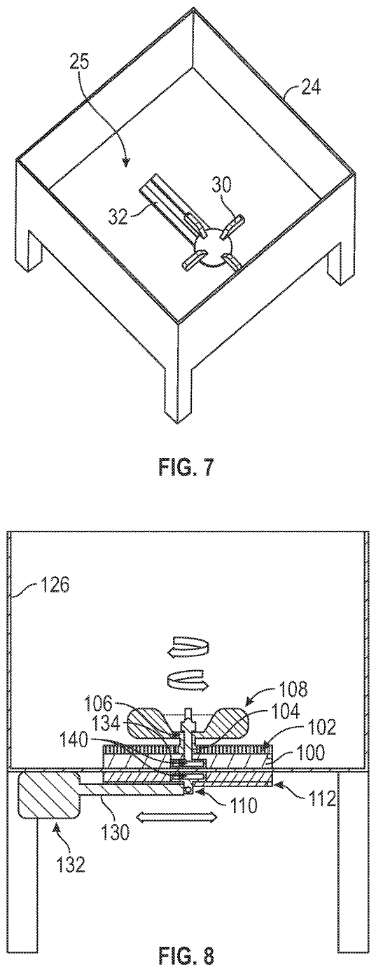

Referring now to FIG. 7, in embodiments, the impeller guide 32 and/or impeller 30 may be located in a central position within the mixer/bioreactor 24. As will be appreciated, however, the guide 32 and impeller 30 may be located anywhere on the bottom surface 27 of the vessel 26 (e.g., adjacent a sidewall or extending on a diagonal) without departing from the invention.

In other embodiments, the guide 32 and impeller 30 may be located on a sidewall of the vessel 26. In such embodiments, the impeller 30 may travel bidirectionally along the sidewall a substantially horizontal impeller travel path. In the case of vessels that are round and have a continuous sidewall, the guide 32 and related components may be curved to match the sidewall and may extend (in a substantially horizontal path) on a portion of (or the entirety of) the circumference of the sidewall.

Similarly, the substantially horizontal impeller travel path need not be linear and may be non-linear, e.g., curved or of various other shapes. In certain embodiments, there may be multiple impellers 30 and/or impeller couplings 32 within the vessel 26. As will be appreciated, the length of the impeller guide 32 may vary depending on the size/volume of the vessel 26 or other criteria.

The impeller 30 and impeller guide 32 may be manufactured from a variety of materials including, but not limited to plastics and metals. In an embodiment, the guide 32 and/or the impeller 30 may include a coating to reduce the emission of particulates caused by contact of the impeller 30 within the guide 32 during use. In an embodiment, ceramic coatings such as a titanium-based coating may be utilized. In other embodiments, polymeric coatings or composites may be employed. The coatings may be located on the impeller 30 and/or the guide 32 and may be applied via known techniques including, but not limited to, additive manufacturing.

As will be appreciated, the number of teeth per unit of linear measurement of the rack of teeth 60 in the coupling guide 62, and/or the circumferential teeth 58 of the actuator coupling 56, e.g., centimeter or inches, may vary without departing from the invention.

Likewise, the shape and size of the teeth may vary without departing from the scope of the invention.

Still further, while the aforementioned embodiments illustrate the use of teeth 58, 60 for effectuating axial rotation of the impeller 30, the invention is not so limited. For example, a belt and pully type mechanism may be implemented. In such an embodiment, the motor 51 may be connected to a belt, such that when the motor is actuated a pulley is rotated which causes rotation of the belt. The belt is connected to the pulley as well as rotatable actuator shaft 63. In this way, actuation of the motor 51 causes the rotatable actuator shaft 63 to turn, effectuating axial rotation of the impeller 30. In embodiments, other various push/pull or similar motors/actuators may be utilized.

Moreover, in certain embodiments, axial rotation of the impeller 30 may be accomplished using a pressurized fluid, e.g., a turbine. In such embodiments, a pressurized fluid may be directed via a nozzle or the like to blades 44 of the impeller 30 to rotate them axially and/or move the impeller about its travel path. The nozzle(s) may be located within the vessel/bag or may be exterior to the mixer/bioreactor 24, and the fluid (e.g., pressurized air) may be directed toward the actuator coupling, or similar structure, to axially rotate the same. In embodiments, the pressurized fluid may be a fluid that is commonly utilized for bioprocessing.

In yet other embodiments, it may be possible to utilize one or more electromagnets in proximity to the coupling guide 62 (e.g., at one or both of the distal ends of the guide 62) to move the coupling 56 along its substantially horizontal coupling travel path. As will be appreciated, reversing polarity of the electromagnet affects a push/pull change to bidirectionally motivate the coupling 56 within the guide 62 causing axial rotation of the coupling 56 and impeller 30.

The mixing efficiency of the rotating impeller 30 disclosed herein is significantly better than fixed impellers because the impeller 30 moves bidirectionally back and forth about a substantially horizontal travel path along the bottom of the vessel. This back-and-forth movement of the impeller 30, whereby the direction of rotation changes when the direction of travel of the impeller 30 within the impeller guide 32 changes, creates a pumping motion that removes settling of particulates that may occur in the bottom of the vessel 26 (typically underneath the fixed impeller in known systems).

This movement of the impeller 30 also allows a single impeller 30 to perform the work of multi-stage fixed location impellers (not depicted) in which multiple impellers are stacked axially about a shaft at the bottom of the interior of a vessel.

While embodiments present an alternative to multiple stacked fixed impellers, in aspects multiple rotatable impellers 30 may travel along the substantially horizontal travel path within the impeller guide 32. In other embodiments, multiple separate impeller guides 32 and/or impellers 30 within a single impeller guide 32 may be employed.

In embodiments, the speed of the linear actuator may be selectively variable. As will be appreciated, in these embodiments the speed may be increased or decreased to change the RPM of the impeller.

In certain embodiments, it may be possible for the impeller to travel about a substantially horizontal travel path without the need for an impeller guide. More specifically, the linear actuator 60 may be operatively connected to a superconducting magnetic material. In such embodiments, the magnetic strength may be sufficient such that movement of an actuator coupling equipped with superconducting magnetic material about a substantially horizontal coupling travel path, may cause reliable rotation and travel of an impeller equipped with permanent magnets about a corresponding impeller travel path within a vessel without the need for an impeller guide.

In embodiments, the actuator may not be a linear actuator, particularly in embodiments where the travel paths are not non-linear. In embodiments, the travel path may be curved or arcuate.

In certain embodiments, the travel path may include multiple linear paths that are angularly/directionally different. In such embodiments, the travel path may have a substantially V or Z shape, among other possible shapes.

Still further, while the aforementioned embodiments illustrate the use of teeth 58, 60 for effectuating axial rotation of the impeller 30, the invention is not so limited. For example, a belt and pully type mechanism may be implemented. In such an embodiment, the motor 51 may be connected to a belt, such that when the motor is actuated a pulley is rotated which causes rotation of the belt. The belt is connected to the pulley as well as rotatable actuator shaft 63. In this way, actuation of the motor 51 causes the rotatable actuator shaft 63 to turn, effectuating axial rotation of the impeller 30.

A method of agitating fluid in a vessel 26 is also disclosed herein. The method includes moving a rotatable impeller 30 in a substantially horizontal impeller travel path, the impeller travel path defined by an impeller guide 32 located within an interior volume 28 of the vessel such that when impeller is moved bidirectionally in the substantially horizontal impeller travel path, the impeller rotates axially to agitate a liquid in the interior volume.

In embodiments, the rotatable impeller is moved in the substantially horizontal travel path via a linear actuator 54. The method further includes changing a speed of the linear actuator 54 to change an RPM of the rotatable impeller.

Referring now to FIG. 8, an alternative embodiment of the invention is depicted. In this embodiment, the impeller guide 100 within the vessel 126 includes a rack of teeth 102 which mate with circumferential teeth 104 that are located on a portion of the impeller 108 capable of rotation about the shaft 106, which is fixed to the impeller base 134. In this embodiment, the actuator coupling 110 and coupling guide 112 do not include teeth and the actuator coupling does not rotate. That is, the actuator coupling 110 is fixed to the linearly extending rod 130 of the actuator 132.

In this embodiment, actuator coupling 110 magnetically engages the base 134 of the impeller 108 via magnets 140. The base 134 also does not rotate but simply moves back and forth along a substantially horizontal impeller travel path. This movement causes the shaft to move without rotation which causes the circumferential teeth 104 of the impeller to engage the rack of teeth 102 in the impeller guide 100 effectuating rotation of the impeller 108.

As will be appreciated, this embodiment is capable of bidirectional movement and when the direction of travel of the base 132 within the impeller guide 100 is reversed, the direction of rotation of the impeller 108 correspondingly reverses.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, terms such as “first,” “second,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

1-17. (canceled)

18. A vessel comprising:
an interior volume configured to contain a liquid;
a rotatable impeller located within the interior volume;
an impeller guide configured to receive the impeller, the impeller guide being located within the interior volume and defining a substantially horizontal impeller travel path; and
wherein when impeller travels along the substantially horizontal impeller travel path, the impeller rotates axially to agitate a liquid in the interior volume.

19. The vessel of claim 18, wherein the substantially horizontal travel path is linear or non-linear.

20. The vessel of claim 18, wherein the rotatable impeller comprises:
a base portion and at least one blade; and
wherein the base portion is received within the impeller guide.

21. The vessel of claim 18, wherein the impeller guide is located on a bottom surface of the vessel and includes an open channel that faces away from the bottom surface, the open channel being configured to retain the base portion of the impeller while the impeller rotates axially as it travels along the substantially horizontal impeller travel path.

22. The vessel of claim 20, wherein the base portion of the impeller includes at least one impeller magnet that allows for control of travel of the impeller along the substantially horizontal impeller travel path.

23. The vessel of claim 22, wherein the at least one impeller magnet is configured for magnetic engagement with an actuator magnet located outside of the vessel, the actuator magnet being operatively connected to an actuator allowing the actuator to move the impeller bidirectionally along the substantially horizontal impeller travel path.

24. The vessel of claim 23, wherein the actuator magnet is located within a rotatable coupling having a plurality of teeth arranged about a circumference of the coupling, the coupling teeth configured to engage a rack of teeth in a coupling guide located outside of the vessel causing the coupling to rotate, the coupling guide further defining a substantially horizontal coupling travel path; and
wherein when the impeller magnet and actuator magnet are magnetically engaged and the coupling travels in the coupling guide along the coupling travel path, the coupling teeth engage the rack of teeth and the coupling rotates, causing the impeller to correspondingly travel along the substantially horizontal impeller travel path and rotate.

25. The vessel of claim 23, wherein the actuator magnet is located within a coupling that is configured to be received in a coupling guide located outside of the vessel, the coupling guide defining a substantially horizontal coupling travel path, the impeller includes a plurality of circumferentially arranged impeller teeth, and the impeller guide includes a rack of teeth configured to engage the plurality of impeller teeth; and
wherein when the impeller magnet and actuator magnet are magnetically engaged and the coupling travels in the coupling travel path, the impeller correspondingly travels in the impeller travel path, causing the impeller teeth to engage the rack of teeth to rotate the impeller.

26. The vessel of claim 18, wherein the vessel is a collapsible, bioreactor bag.

27. A stirred tank comprising:
an interior configured to receive a vessel, the vessel containing an impeller capable of axial rotation and travel along a substantially horizontal impeller travel path, the vessel configured to receive a fluid;
an exterior that defines the interior volume;
a coupling guide affixed to the exterior of the stirred tank, the coupling guide defining a substantially horizontal coupling travel path; and
wherein the coupling guide is configured to receive an actuator coupling containing at least one magnet, the actuator coupling configured for magnetic engagement with the impeller such that when the actuator coupling travels within the coupling guide in the coupling travel path, the impeller travels along the substantially horizontal impeller travel path and rotates.

28. The stirred tank of claim 27, further comprising:
an actuator affixed to the exterior of the stirred tank, the actuator operatively connected to the actuator coupling and operable to move the actuator coupling bidirectionally along the coupling travel path.

29. The stirred tank of claim 27, wherein the coupling guide includes a rack of teeth, and the coupling includes a plurality of circumferentially arranged coupling teeth, the coupling teeth configured to engage the rack of teeth causing the coupling to rotate; and
wherein when the impeller and actuator magnet are magnetically engaged and the coupling travels in the coupling guide, the coupling teeth engage the rack of teeth and rotate, causing the impeller to correspondingly travel along the substantially horizontal impeller travel path and rotate.

30. The stirred tank of claim 27, wherein the vessel includes an impeller guide, which defines the substantially horizontal impeller travel path and includes a rack of teeth configured to engage a plurality of impeller teeth circumferentially arranged on the impeller; and
wherein when the impeller and actuator magnet are magnetically engaged and the coupling travels in the coupling travel path, the impeller correspondingly travels in the impeller travel path, causing the impeller teeth to engage the rack of teeth to rotate the impeller.

31. A method of agitating fluid in a vessel comprising:
moving a rotatable impeller in a substantially horizontal impeller travel path, the impeller travel path defined by an impeller guide located within an interior volume of the vessel; and
wherein when impeller is moved in the substantially horizontal impeller travel path, the impeller rotates axially to agitate a liquid in the interior volume.

32. The method of claim 31 further comprising:
moving the rotatable impeller bidirectionally along the substantially horizontal travel path.

33. The method of claim 32 wherein the rotatable impeller is moved in the substantially horizontal travel path via a linear actuator.

34. The method of claim 33 further comprising:
changing a speed of the linear actuator to change an RPM of the rotatable impeller.
